(19) United States
(12) Patent Application Publication
(10) Pub. No.: US 2026/0129417 A1
(43) Pub. Date: May 7, 2026

(54) HANDLING OF RAT UTILIZATION UNDER DISASTER CONDITIONS

(71) Applicant: InterDigital Patent Holdings, Inc., Wilmington, DE (US)

(72) Inventors: Anuj Sethi, Ottawa (CA); Michael Starsinic, Newtown, PA (US); Samir Ferdi, Kirkland (CA); Taimoor Abbas, Sainte-Julie (CA); Saad Ahmad, Montreal (CA)

(73) Assignee: InterDigital Patent Holdings, Inc., Wilmington, DE (US)

(21) Appl. No.: 18/940,459

(22) Filed: Nov. 7, 2024

(51) Int. Cl. H04W 4/90; H04W 8/02; H04W 24/04; H04W 48/18; H04W 60/04; H04W 84/04

(52) U.S. Cl. CPC H04W 4/90; H04W 8/02; H04W 24/04; H04W 48/18; H04W 60/04; H04W 84/042

(57) ABSTRACT

Systems, methods, and devices for handling of RAT utilization under disaster conditions. The WTRU registers with a first public land mobile network (PLMN) on a first radio access technology (RAT). The WTRU receives, from the first PLMN, information indicating that a restriction on a second RAT is applicable for the first PLMN. The WTRU receives information indicating that the first PLMN is under a disaster condition. The WTRU transmits a registration request to a second PLMN. The WTRU receives a registration rejection message from the second PLMN. The WTRU receives, from the second PLMN, information indicating that the restriction on the second RAT is not applicable for the first PLMN. The WTRU registers with the first PLMN on the second RAT.

### BACKGROUND

Roaming services may provide connectivity for wireless transmit/receive units (WTRUs), e.g., in areas where a primary network operator lacks coverage. Allowing the WTRU to have unrestricted use of Radio Access Technologies (RAT) during roaming may, in some cases, result in technical challenges, such as interoperability issues, quality of service concerns and network congestion concerns. Accordingly, in some cases, a WTRU may be restricted from using a particular RAT, e.g., when roaming.

### SUMMARY

Some implementations provide systems, methods, and devices for handling of RAT utilization under disaster conditions. The WTRU registers with a first public land mobile network (PLMN) on a first radio access technology (RAT). The WTRU receives, from the first PLMN, information indicating that a restriction on a second RAT is applicable for the first PLMN. The WTRU receives information indicating that the first PLMN is under a disaster condition. The WTRU transmits a registration request to a second PLMN. The WTRU receives a registration rejection message from the second PLMN. The WTRU receives, from the second PLMN, information indicating that the restriction on the second RAT is not applicable for the first PLMN. The WTRU registers with the first PLMN on the second RAT.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a message sequence chart illustrating an example procedure for delivery and handling of information for RAT utilization under disaster handling conditions;

FIG. 3 is a flow chart illustrating an example method for RAT utilization handling under disaster conditions, with pre-disaster configuration;

FIG. 4 is a message sequence chart illustrating aError! Reference source not found.n example procedure for a WTRU which receives RAT utilization information applicability per PLMN after a disaster has occurred;

FIG. 5 is a flow chart illustrating an example method 500 for RAT utilization handling under disaster conditions, with post-disaster provisioning; and

FIG. 6 is a flowchart illustrating an example method for handling of RAT utilization under disaster conditions.

### DETAILED DESCRIPTION

Some implementations provide a method for use in a wireless transmit/receive unit (WTRU). The WTRU registers with a first public land mobile network (PLMN) on a first radio access technology (RAT). The WTRU receives, from the first PLMN, information indicating that a restriction on a second RAT is applicable for the first PLMN. The WTRU receives information indicating that the first PLMN is under a disaster condition. The WTRU transmits a registration request to a second PLMN. The WTRU receives a registration rejection message from the second PLMN. The WTRU receives, from the second PLMN, information indicating that the restriction on the second RAT is not applicable for the first PLMN. The WTRU registers with the first PLMN on the second RAT.

In some implementations, the information indicating that the first PLMN is under the disaster condition is received in a broadcast from the second PLMN. In some implementations, the broadcast comprises a system information block (SIB). Some implementations also include requesting an additional SIB that includes information indicating that the restriction on the second RAT is not applicable for the first PLMN, and location information, responsive to the broadcast SIB. In some implementations, the registration request to the second PLMN indicates a request for disaster roaming service. In some implementations, the registration request to the second PLMN indicates a request for normal service. In some implementations, the registration rejection message from the second PLMN includes information indicating that the restriction on the second RAT is not applicable to the WTRU for the first PLMN. In some implementations, the information indicating that the first PLMN is under the disaster condition includes location information, wherein the information indicating that the restriction on the second RAT is not applicable to the WTRU for the first PLMN is applicable within a geographic area that is based on the location information. In some implementations, the first RAT comprises a 5G RAT. In some implementations, the second RAT comprises a 4G RAT.

Some implementations include a WTRU. The WTRU includes circuitry configured to register with a first PLMN on a first RAT. The WTRU also includes circuitry configured to receive, from the first PLMN, information indicating that a restriction on a second RAT is applicable for the first PLMN. The WTRU also includes circuitry configured to receive information indicating that the first PLMN is under a disaster condition. The WTRU also includes circuitry configured to transmit a registration request to a second PLMN. The WTRU also includes circuitry configured to receive a registration rejection message from the second PLMN. The WTRU also includes circuitry configured to receive, from the second PLMN, information indicating that the restriction on the second RAT is not applicable for the first PLMN. The WTRU also includes circuitry configured to register with the first PLMN on the second RAT.

In some implementations, the circuitry configured to receive the information indicating that the first PLMN is under the disaster condition is configured to receive the information indicating that the first PLMN is under the disaster condition in a broadcast from the second PLMN. In some implementations, the broadcast is or includes a SIB. In some implementations, the WTRU includes circuitry configured to receive an additional SIB that includes information indicating that the restriction on the second RAT is not applicable for the first PLMN, and location information, responsive to the broadcast SIB. In some implementations, the registration request to the second PLMN indicates a request for disaster roaming service. In some implementations, the registration request to the second PLMN indicates a request for normal service. In some implementations, the registration rejection message from the second PLMN includes information indicating that the restriction on the second RAT is not applicable to the WTRU for the first PLMN. In some implementations, the information indicating that the first PLMN is under the disaster condition includes location information, wherein the information indicating that the restriction on the second RAT is not applicable to the WTRU for the first PLMN is applicable within a geographic area that is based on the location information. In some implementations, the first RAT is or includes a 5G RAT. In some implementations, the second RAT is or includes a 4G RAT.

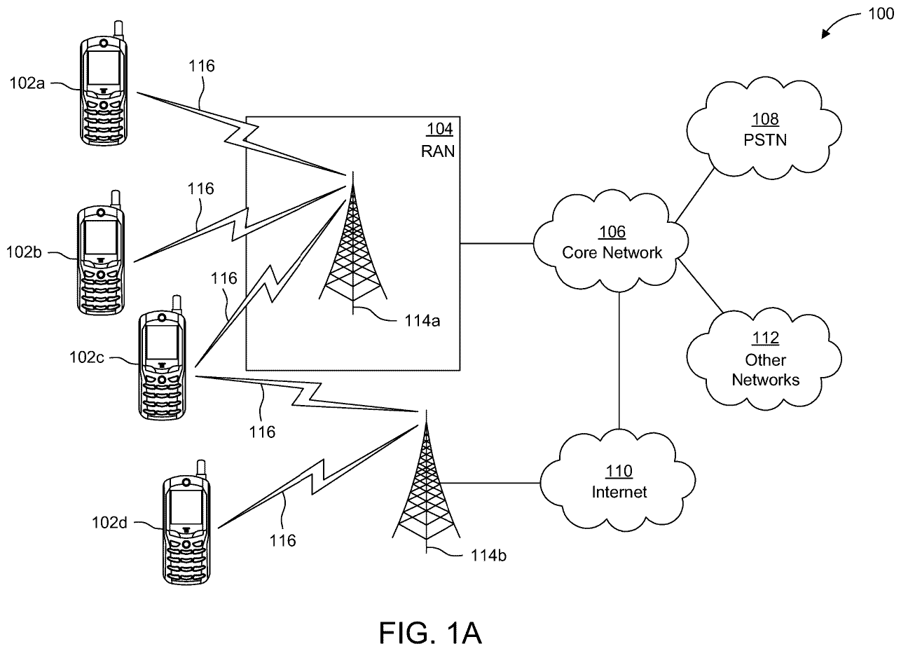

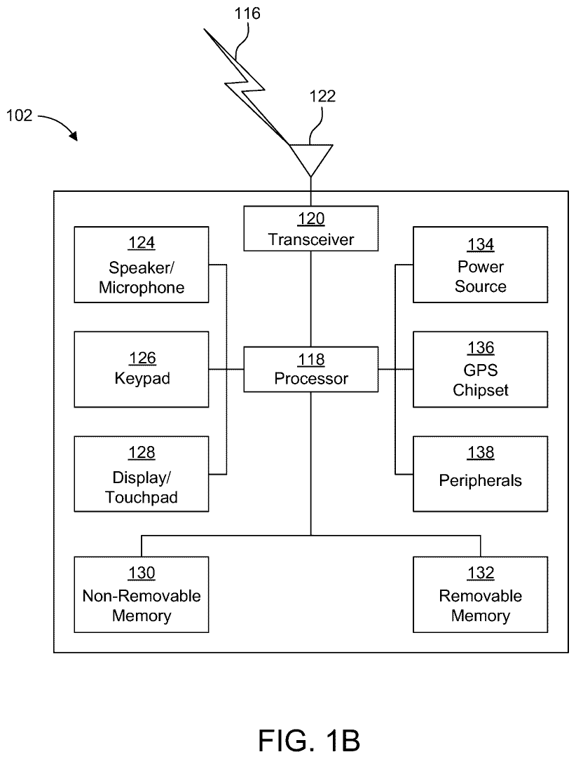

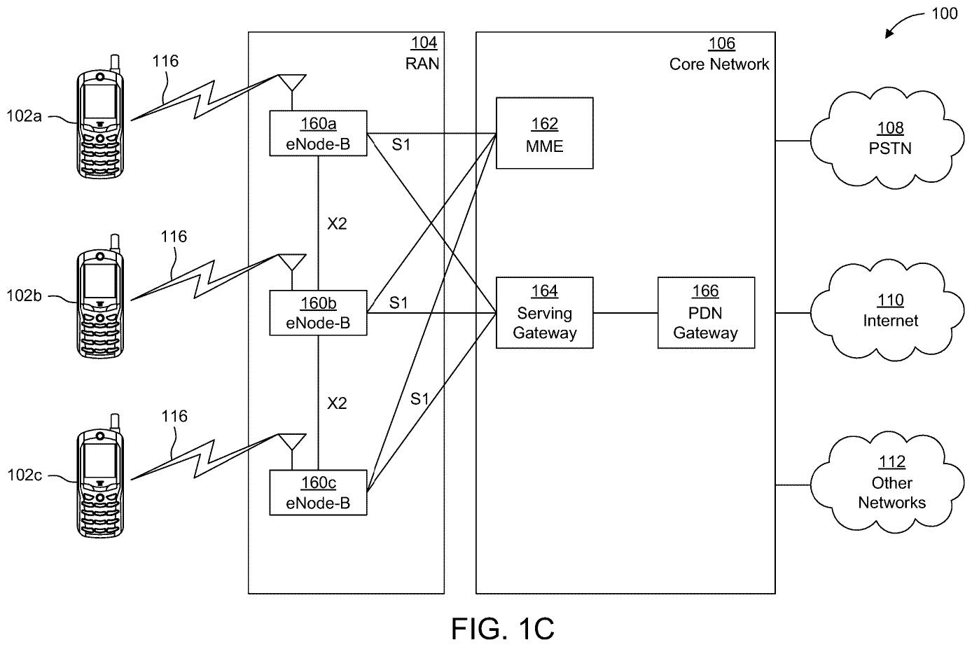

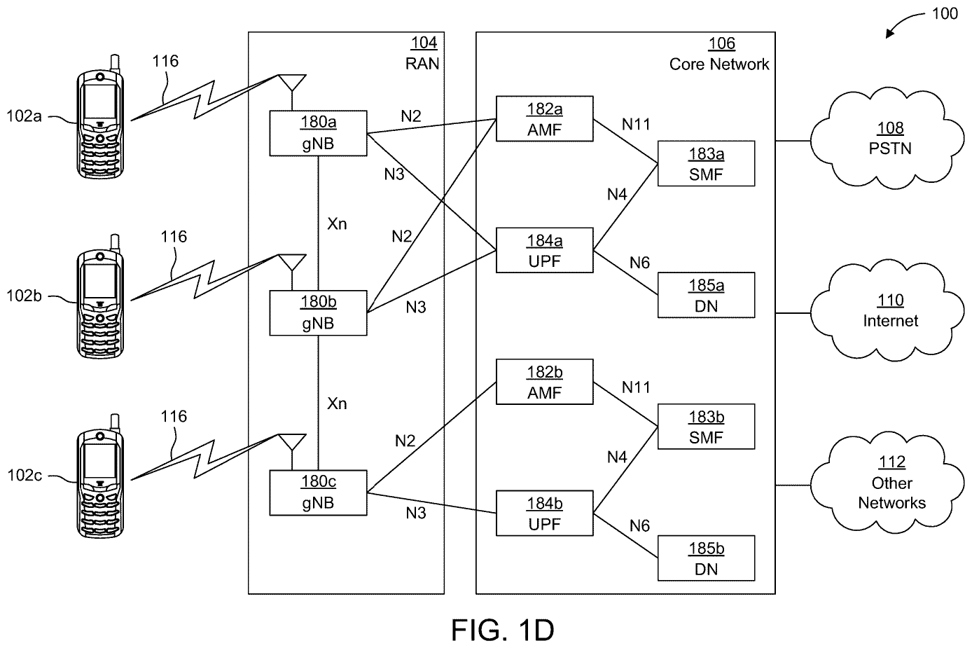

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station (MS), a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). UTRA is an example of a third generation (3G) RAT. WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro). E-UTRA, LTE, LTE-A, and LTE-A are examples of fourth generation (4G) RATs.

In an embodiment, the base station 114a and the WTRUs 102a, 102b, 102c may implement a radio technology such as NR Radio Access, which may establish the air interface 116 using NR. NR is an example of a fifth generation (5G) RAT.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following acronyms, among others, are used in this document:

| | |
|---|---|
| AMF | Access and Mobility Function |
| AF | Application Function |
| CAG | Closed Access Group |
| EHPLMN | Equivalent Home PLMN |
| eHN | Equivalent Hosting Networks |
| FPLMN | Forbidden PLMN |
| eSNPN | Equivalent SNPNs |
| GUI | Graphical User Interface |
| GIN | Group ID for Network Selection |
| HPLMN | Home Public Land Mobile Network |
| IE | Information Element |
| IMSI | International Mobile Subscriber Identity |
| MCC | Mobile Country Code |
| MNC | Mobile Network Code |
| MS | Mobile Station |
| NAS | Non-Access Stratum |
| NG | Next Generation |
| NPN | Non-Public Network |
| NS | Network Slicing |
| NSSAI | Network Slice Selection Assistance Information |
| NSSAA | Network Slice-Specific Authentication and |
| | Authorization |
| NWDAF | Network Data Analytics Function |
| OPLMN | Operator Controlled PLMN (Selector List) |
| PALS | Providing Access to Localized Services |
| PLMN | Public Land Mobile Network |
| PNI-NPN | Public Network Integrated NPN |
| RA | Registration Area |
| RAN | Radio Access Network |
| RAT | Radio Access Technology |
| RFSP | RAT / Frequency Selection Priority |
| RPLMN | Registered Public Land Mobile Network |
| S-NSSAI | Single NSSAI |
| SIM | Subscriber Identity Module |
| SoR | Steering of Roaming |
| SoR-SNPN-SI-LS | SoR SNPN Selection Information for Localized |
| | Services |
| TA | Tracking Area |
| TAI | TA Identity |
| UE | User Equipment |
| SNPN | Standalone NPN |
| UICC | Universal Integrated Circuit Card |
| USIM | UICC with SIM |
| VPLMN | Visited Public Land Mobile Network |

As used herein, the term access technology refers to an access technology associated with a PLMN or SNPN. For example, in some implementations, a WTRU (e.g., MS) uses access technology information to determine what type or types of radio carrier to search for when attempting to select a specific PLMN or SNPN. In some implementations, example access technologies include GSM, UTRAN, GSM COMPACT, EC-GSM-IoT, cdma2000 1×RTT, cdma2000 HRPD, E-UTRAN (e.g., WB-S1 mode and NB-S1 mode), NG-RAN, satellite NG-RAN and satellite E-UTRAN (e.g., WB-S1 mode and NB-S1 mode). In some implementations, a PLMN may support more than one access technology. In some implementations, SNPNs only support NG-RAN.

As used herein, the term allowable PLMN refers to a PLMN which is not forbidden. For example, in some implementations, e.g., in the case of a WTRU (e.g. MS) operating in operation mode A or B (e.g., MS operation mode A or B), an allowable PLMN may be a PLMN which is not on a list or other indication of “forbidden PLMNs” in the MS. In some implementations, e.g., in the case of a WTRU (e.g. MS) operating in operation mode C (e.g., MS operation mode C) or a WTRU (e.g., MS) not supporting A/Gb mode and not supporting Iu mode, an allowable PLMN is a PLMN which is not in the list or other indication of “forbidden PLMNs” and not in the list or other indication of “forbidden PLMNs for GPRS service” in the WTRU (e.g., MS). The MS operation modes refer to different modes in which a MS (e.g. WTRU) can operate when it is in a dual-mode or multi-mode network. MS operation mode A means MS is operating in single-mode operation i.e. MS is capable of using only GPRS services and does not support circuit-switched services simultaneously. MS operation mode B means MS is operating in dual-mode operation, where it can switch between GSM circuit-switched services (like voice calls) and packet-switched services (like GPRS data), however the MS can use either GSM or GPRS services but cannot use them both simultaneously. MS operation mode C means the MS can simultaneous use of both circuit-switched (voice) and packet-switched (data) services.

As used herein, the term allowable SNPN refers to an SNPN which is not forbidden. For example, in some implementations, e.g., in the case of a WTRU (e.g., MS) operating in SNPN access operation mode over 3GPP access and for an SNPN candidate which is not an SNPN selected for localized services in SNPN, an allowable SNPN may be an SNPN which is not on alist of “permanently forbidden SNPNs” and/or in some implementations, which is (e.g., if the WTRU supports access to an SNPN using credentials from a credentials holder, equivalent SNPNs or both) associated with the selected entry of a “list of subscriber data” or a selected PLMN subscription, and/or in some implementations, which is not on a list of “temporarily forbidden SNPNs” which is (if the WTRU supports access to an SNPN using credentials from a credentials holder, equivalent SNPNs or both) associated with a selected entry of the “list of subscriber data” or the selected PLMN subscription. In some implementations, e.g., where the WTRU (e.g., MS) is operating in SNPN access mode and for an SNPN candidate which is an SNPN selected for localized services in SNPN, an allowable SNPN is an SNPN which is not on a list of “permanently forbidden SNPNs for access for localized services in SNPN” which is associated with a selected entry of a “list of subscriber data” or a selected PLMN subscription, and is not on a list of “temporarily forbidden SNPNs for access for localized services in SNPN” that is associated with the selected entry of the “list of subscriber data” or the selected PLMN subscription.

As used herein, the term allowable PLMN/access technology combination refers to an access technology by which the WTRU is not restricted from accessing the PLMN. For example, in the case of a WTRU (e.g., MS) operating in operation mode C or a WTRU (e.g., MS) not supporting A/Gb mode and not supporting Iu mode, an allowable PLMN/access technology combination is an allowable PLMN in any specific access technology. For example, in the case of a WTRU operating in MS operation mode A or B, an allowable PLMN/access technology combination is a PLMN/access technology combination where:
the PLMN is an allowable PLMN and the specific access technology supports non-GPRS services; or
the PLMN is not in a list of “forbidden PLMNs” and not in the a of “forbidden PLMNs for GPRS service” in the WTRU, and the specific access technology only supports GPRS services.

As used herein, the term camped on a cell refers to a WTRU (e.g., MS, or ME if there is no SIM) that has completed the cell selection and/or reselection process and has chosen the cell, from which it plans to receive all available services. It is noted that the services may be limited, and that the PLMN or the SNPN may not be aware of the existence of the WTRU (e.g., MS or ME) within the chosen cell. For example, in some implementations, the camped cell may provide normal services (e.g., where the cells belongs to an allowable PLMN) or limited services (e.g., emergency, PWS etc., when the chosen cell does not belongs to an allowable PLMN—e.g., is a forbidden PLMN.)

As used herein, the term current serving cell refers to a cell upon which the WTRU (e.g., MS, or ME if there is no SIM) is camped.

As used herein, the term home PLMN (HPLMN) refers to a PLMN where the MCC and MNC of the PLMN identity match the MCC and MNC of the IMSI.

As used herein, the term visited PLMN (VPLMN) refers to a PLMN different from the HPLMN (e.g., if an equivalent HPLMN (EHPLMN) list is not present, e.g., in a USIM, or is empty) or different from an EHPLMN (e.g., if an EHPLMN list is present).

As used herein, the term in A/Gb mode refers to information that applies to, or applies only to a GSM system which operates in A/Gb mode. In some implementations, e.g., in a multi system scenario, this is determined by the current serving radio access network.

As used herein, the term in Iu mode refers to information (e.g., a clause) that applies to, or applies only to UMTS. In some implementations, e.g., in a multi system scenario, this is determined by the current serving radio access network.

As used herein, the term in S1 mode refers to information (e.g., a clause) that applies to, or applies only to an EPS. In some implementations, the S1 mode includes WB-S1 mode and NB-S1 mode. In some implementations, e.g., in a multi system scenario, this is determined by the current serving radio access network.

As used herein, the term in N1 mode refers to information (e.g., a clause) that applies to, or applies only to a 5GS. For multi system case this is determined by the current serving radio access network.

As used herein, the term registered PLMN (RPLMN) refers to a PLMN on which certain LR outcomes have occurred. In some implementations, n a shared network, the RPLMN is the PLMN defined by the PLMN identity of the CN operator that has accepted the LR.

As used herein, the term registration refers to the process of a WTRU camping on a cell of the PLMN or the SNPN and performing any necessary LRs.

As used herein, the term selected PLMN refers to a PLMN that has been selected, either manually or automatically.

As used herein, the term steering of roaming (SOR) refers to a technique whereby a roaming WTRU is encouraged to roam to a preferred roamed-to-network indicated by the HPLMN. As used herein, the term steering of roaming application function (SOR-AF) refers to an application function that can provide UDM with one of the following: a) one or more of the following: a list of preferred PLMN/access technology combinations; a SOR-CMCI, together with an indication to store SOR-CMCI in the WTRU (e.g., ME), if applicable; a SOR-SNPN-SI; and/or SOR-SNPN-SI-LS; b) a secured packet, together with an indication, if applicable, that the list of preferred PLMN/access technology combinations is not included in the secured packet; or c) neither a nor b. In some implementations, the options a, b, and c may be generated dynamically based on operator specific data analytics solutions.

As used herein, the terms RAN Node, Base Station (BS), eNodeB, and gNodeB, are used interchangeably.

As used herein, the terms PLMN with disaster condition and PLMN under disaster conditions refers to a PLMN to which a disaster condition applies. An example PLMN with disaster condition may be referred to as PLMN-D herein.

As used herein, the terms PLMN without disaster condition and PLMN not under disaster conditions refer to a PLMN to which no disaster condition applies. Example PLMNs without disaster condition may be referred to as PLMN-A and/or PLMN-X.

As used herein, PLMN supporting disaster inbound roaming refers to A PLMN (e.g., PLMN-A) which supports disaster inbound roaming from a PLMN under disaster conditions (e.g., PLMN-D).

Some implementations relate to non-public networks (NPN). In some implementations, a NPN is or includes a 5GS deployed network which is for non-public use. In some implementations, an NPN is either a stand-alone non-public network (SNPN) (i.e., operated by an NPN operator and/or not relying on network functions provided by a PLMN), or a public network integrated NPN (PNI-NPN) (i.e., a non-public network deployed with the support of a PLMN).

In some implementations, a NPN is intended for the use of a private entity such as an enterprise or a factory. In some implementations, an SNPN is identifiable by a combination of PLMN ID and Network Identifier (NID), e.g., where the PLMN ID may be a PLMN ID reserved for private networks (e.g., with Mobile Country Code=999).

The architecture of a 5G SNPN is based on the architecture of 5G System. In some implementations, the NG-RANs of the SNPN broadcast the combination of PLMN IDs and NIDs. In some implementations, a WTRU operating in SNPN access mode reads the broadcast system information for available PLMN IDs and available NIDs and selects the SNPN for which it has a subscription and credentials.

Some implementations relate to public network integrated non-public networks (PNI-NPN). In some implementations, a PNI-NPN is a NPN made available using PLMN infrastructure and/or resources (e.g., a PLMN network slice). In some implementations, a group of PLMN users which are allowed to access a certain PNI-NPN is referred to as a closed access group (CAG). In some implementations, a CAG may be identified by a CAG identifier. In some implementations, CAG users can only access a PNI-NPN from a cell that supports CAG access, which may be referred to as a CAG cell. In some implementations, a CAG cell broadcasts a list of CAG identifiers that it supports. In some implementations, a CAG WTRU is configured by the network (e.g., by a mobile network entity, such as 5GC/AMF) with a list of CAGs that it can access (e.g., by receiving an allowed CAG list from the network). In some implementations, if a CAG WTRU detects a CAG cell, the CAG WTRU may only select and/or access the CAG cell if at least one of the broadcasted CAG identifiers matches one of the CAG identifiers in its allowed CAG list.

Some implementations relate to networks providing access to localized services (PALS networks). In some implementations, a PALS network may be or include a cellular network deployed to provide services to local users within a certain area. For example, in some implementations, a temporary non-public cellular network may be set up to provide a streaming video service to an audience (e.g., an audience of a live concert or a football match, etc.) In another example, a PALS network may be or include a cellular network deployed to provide localized services (e.g., commercial advertisements) in places where a large crowd may gather (e.g., airports, shopping malls and/or school campuses, etc.)). In some implementations, services provided by such small networks may have two basic characteristics: first, the services are localized, meaning that they are related to the activities/events in a certain spot or area and may be limited to the users within the area; and second, that the users do not typically utilize the services on a regular basis but typically utilize the services in an on-demand or temporary fashion.

In some implementations, 5G system enhancements may be desired to provide such localized services and/or to enable users to access a hosting network that provides such services. Such localized services may be referred to as PALS services or localized services, and a network that provides such PALS services may be referred to as a PALS network, PALS hosting network, or hosting network.

In some implementations, a hosting network may be or include a standalone non-public network (SNPN), a public network integrated non-public network (PNI-NPN), and/or or a PLMN. In some such implementations, a local service provider may be a hosting network operator or may be a third-party service provider.

Some implementations relate to a network selection process. In some implementations, network selection refers to a process by which a WTRU performs a radio scan to check whether PLMNs are available at its current location, and attempts to register to the PLMN (e.g., using rules defined in 3GPP standards for the PLMN selection process).

In some implementations, a WTRU may (e.g., at switch-on, or following recovery from lack of coverage) select a PLMN with which the WTRU was last registered, using the last registered access technology, and may perform a registration procedure with the selected PLMN. If the PLMN with which the WTRU was last registered is not available, the WTRU may scan RF channels (e.g., all RF channels) in all supported bands (e.g., radio frequencies which the WTRU may scan to find deployed PLMNs) and access technologies according to its capabilities (e.g., radio capabilities of the WTRU with respect to which all radio frequencies it can scan) to find available PLMNs.

In some implementations, the WTRU may search for the strongest cell on each carrier (i.e. channel), and may read the system information of that cell. In some implementations, the system information is read to find out which PLMN the cell belongs to.

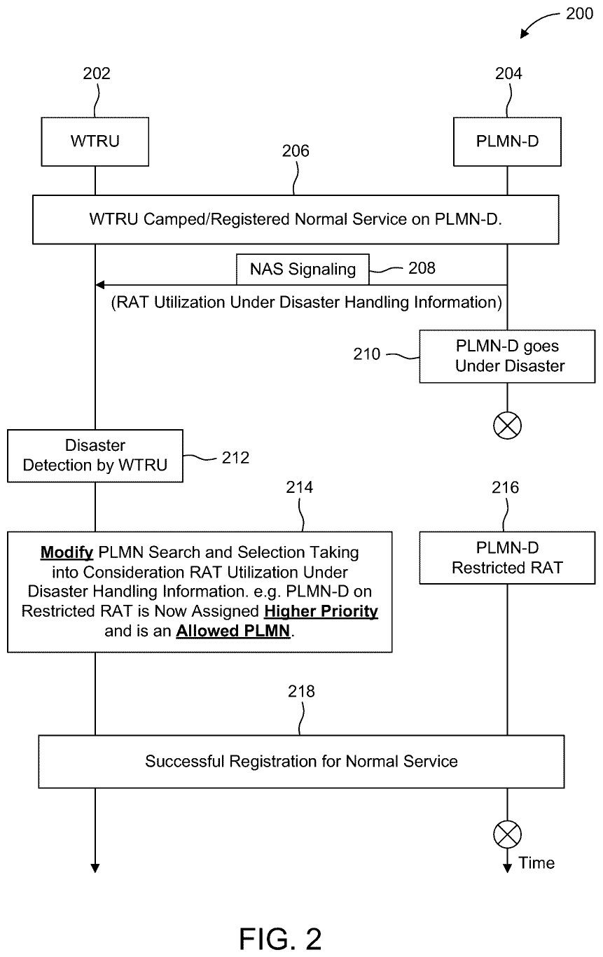

If there is no last registered PLMN, or if registration with a last registered PLMN is not possible (e.g., due to the PLMN being unavailable or due to registration failure), the WTRU may follow suitable procedures (e.g., the procedures in clause 4.4.3 and as illustrated in FIGS. 2a in clause 5 of reference TS 23.122) depending on its network selection mode (e.g., automatic vs manual mode of selection).

In some implementations, the priority order for the network selection and registration for the PLMN/Access technologies combination is as follows:
First, either the HPLMN (if the EHPLMN list is not present or is empty) or the highest priority EHPLMN that is available (if the EHPLMN list is present) is selected.
Next, each PLMN/access technology combination in a user controlled PLMN selector with access technology data file in the SIM (in priority order). In some implementations, the file is stored in a USIM/UICC and not stored in the memory of the MS. In some implementations, as an implementation option, the file may be stored in the WTRU as well. In some implementations this file is used the user to prioritize specific networks and preferred access technologies (e.g. 5G/LTE).
Next, each PLMN/access technology combination in the operator controlled PLMN selector with access technology data file in the SIM (in priority order) or stored in the WTRU (e.g., ME) (in priority order);
Finally, other PLMN/access technology combinations with received high quality signal (e.g., as defined by a threshold decibel (db) level, which may be received by the WTRU NAS Layer from the AS layer, which may receive this input from the radio front end of the WTRU) in random order;

Some implementations relate to equivalent PLMNS. In some implementations, a WTRU may be configured with information regarding equivalent PLMNs (e.g., in a list). In some implementations, this information is provided by the network to the WTRU via the registration procedure (e.g., initial or mobility/periodic registration procedure). The PLMNs that are in the list of equivalent PLMNs are regarded by the WTRU as equivalent to each other for PLMN selection and cell selection/re-selection.

Configuring the WTRU with alist of equivalent PLMNs means that the WTRU receives alist of equivalent PLMNs from the network and then the WTRU stores the list of equivalent PLMNs in memory. For example, the WTRU may receive the list of equivalent PLMNs in a Registration Accept message and then the WTRU may store the list of equivalent PLMNs in memory.

In some implementations, the list of equivalent PLMNs is a list of PLMN IDs. Each PLMN ID is composed of at least an MNC and an MCC.

It may be possible to derive a PLMN ID from the WTRU's SUPI. For example, an IMSI is a type of SUPI and an IMSI can contain a PLMN ID. The PLMN ID that is derived from the WTRU's SUPI is the PLMN ID of the WTRU's home network operator. In some implementations, the WTRU may also be configured with an Equivalent HPLMN list. The Equivalent HPLMN list is a list of PLMN IDs, and the WTRU regards the PLMN(s) in this list as equivalent to each other for PLMN selection and cell selection/re-selection.

Some implementations relate to Minimization of Service Interruption (MINT) Minimization of Service Interruption (MINT) is a feature that enables a WTRU of a selected PLMN (PLMN D) with Disaster Condition (e.g., one or more NG-RAN nodes down), to select and register to another PLMN (PLMN A) without Disaster Condition when no other PLMN is available and PLMN A accepts Disaster Inbound Roamers from PLMN DError! Reference source not found. In some implementations, Subject to regulatory requirements, operator's policy or WTRU capabilities, the 3GPP system shall be able to support a WTRU, with 5G-only national roaming access to a VPLMN, to obtain 4G connectivity service from that VPLMN in the area where a Disaster Condition applies. In the above scenario, voice call service is provided by IMS in HPLMN.

In the above scenario, the WTRU still receives service from IMS in HPLMN and only connectivity from VPLMN. This requirement allows 5G-only national roaming WTRUs to register for Disaster Roaming service in EPS of the same VPLMN. As a result, the 4G system shall be able to provide Disaster Roaming service. It is valuable to further evaluate and provide solution to fulfil the above SA1 requirement.

Additionally, it could be a valid network deployment that the operator deploys 5G system and 4G system with different PLMN IDs to ensure that 5G-only national roaming WTRUs cannot access 4G in normal conditions. When the network's 5G RAN is in the disaster condition and it's 4G network provides Disaster Roaming service, 5G-only national roaming WTRUs can select the 4G network from the forbidden PLMN list to register for Disaster Roaming service

Some implementations relate to Enhancement of controlling RAT utilization (ECRATU). National roaming services are vital for ensuring seamless connectivity, especially in areas where the primary network operator lacks coverage. Allowing unrestricted use of Radio Access Technologies (RAT) for national roamers can result in technical challenges including interoperability issues, quality of service concerns and network congestion concerns.

The current mechanism to limit the WTRUs utilization of certain RAT employed by the network operators involves rejecting the WTRU's attach/TAU request or the registration request with CC #15 or #27 upon the WTRU attempts to attach/register via a specific RAT. However, this existing mechanism resulted in: higher signaling loads within the network; service outage until the WTRU selects another RAT; and WTRU keeping re-attempting on the same PLMN/RAT upon the WTRU re-enabling the corresponding RAT.

The network operator may restrict subscriber's access to certain RAT. For this purpose, the network may send the RAT utilization control information to the WTRU via the NAS signaling messages e.g. Attach/Tracking area update accept. The WTRU shall not consider any PLMN and RAT combination with RAT restriction as a candidate PLMN for PLMN selection, cell selection and cell reselection purposes.

In an example scenario, a WTRU is authorized for national roaming only on a specific RAT (e.g., 5G), whereas the WTRU is restricted from roaming on another specific RAT (e.g., 4G). The WTRU may be restricted by enabling a RAT utilization feature, and the restriction may be indicated to the WTRU by the network operator.

In a situation where the WTRU is not allowed to remain connected to the 5G RAT (e.g., due to a received indication of a disaster condition), an issue may arise where the WTRU is unable to connect to any RAT if the only other available RAT is 4G, since the WTRU is restricted from moving to the 4G RAT (e.g., selecting the PLMN on 4G RAT/access technology to obtain normal services, e.g., based on the RAT utilization feature). Accordingly, it may be desired to implement devices, systems, methods, and techniques to address this issue.

In an example scenario, the WTRU may receive RAT utilization information for a first PLMN. The RAT utilization information may indicate that the WTRU is not allowed to access the PLMN via a 4G RAT but that the WTRU is allowed to access the PLMN via a 5G RAT. Later, the WTRU may use the 5G RAT to obtain network access from the PLMN. While using the 5G RAT to access the PLMN, the WTRU may detect that the 5G RAN of the PLMN is under a disaster condition. Based on detecting that the PLMN is in a disaster condition, the WTRU may begin disaster roaming procedures. In this example situation, a second PLMN may be available to serve the WTRU, but may be unwilling to serve the WTRU because the 4G RAT of the first PLMN is available to serve the WTRU. Thus, the issue may arise where the WTRU is unable to connect to any RAT, since the only other available RAT on the first PLMN is 4G, and the WTRU is restricted from moving to the 4G RAT (e.g., based on the RAT utilization feature).

Accordingly, in some implementations, it may be desired to create and/or enhance disaster roaming procedures and/or RAT utilization information to facilitate detection and/or determination by the WTRU of whether RAT utilization information should be ignored (e.g., under disaster conditions), and/or whether to ignore RAT utilization information (e.g., under disaster conditions).

In some implementations, devices, systems, methods, and techniques (e.g., 5G wireless devices, systems, methods, and techniques) may be enhanced to address the issues described above. In some implementations, devices, systems, methods, and techniques (e.g., 5G wireless devices, systems, methods, and techniques) may be provided to address WTRU and/or network behavior to coordinate RAT restriction and disaster condition handling, to handle RAT restriction under disaster conditions, and/or to determine and/or define what information or what kind of information should be delivered to the WTRU before, after, and/or during when the disaster conditions are applicable.

Some implementations provide enhancements, e.g., to the 5G system, for managing RAT Utilization information during disaster conditions. Some implementations include pre-disaster configuration and/or post-disaster provisioning. Here, configuration refers to information which is configured in the WTRU before a disaster occurs, and provisioning refers to providing this information after the disaster conditions occur, or during the disaster conditions.

In an example pre-disaster configuration approach, a RAT utilization under disaster handling information is either pre-configured in the WTRU (e.g., ME) or USIM or provided to the WTRU (e.g., UE) via NAS signaling before a disaster occurs. In some implementations, the RAT utilization under disaster handling information is an information element (IE) which provides information on the handling of the RAT utilization information when and if the network goes under disaster conditions. In some implementations, this IE is referred to by another name. In some implementations, if a disaster is detected, the WTRU may use this pre-configured information, e.g., to adjust its network search and selection algorithm. In some implementations, this adjustment enables the WTRU to find suitable and/or permissible PLMNs, e.g., to obtain normal service. In some implementations, normal service includes access by the WTRU to voice and data for normal services (e.g., for making voice/telephone calls and/or browsing internet data etc.).

In an example post-disaster provisioning approach, a WTRU may receive RAT Utilization information applicability per PLMN, possibly along with optional location information, after a disaster has occurred (e.g., after a disaster condition has begun). In some implementations, the RAT Utilization information applicability per PLMN information (which may be referred to by another name in some implementations) indicates to the WTRU whether or not the RAT Utilization information stored for the PLMN is applicable under the disaster condition. In some implementations, the location information may be or include geo-fence information and/or a list of tracking areas, etc., which when provided restricts the applicability of the RAT Utilization information applicability per PLMN information to an area indicated by the provided location information (e.g. list of tracking areas, geo-fence). In some implementations, this information may be broadcast by PLMNs which are not under disaster conditions (e.g., through system information (SIB) broadcasts or NAS signaling messages). In some implementations, the WTRU may receive the information and may use this information, e.g., to modify its network search and selection algorithm. In some implementations, this adjustment enables the WTRU to find appropriate and permissible PLMNs, e.g., to obtain normal service.

FIG. 2 is a message sequence chart illustrating an example procedure 200 for delivery and handling of information for RAT utilization under disaster handling conditions (e.g., “RAT utilization under disaster handling information”). This information may be referred to as a pre-disaster configuration, e.g., since it is delivered to WTRU 202 before the disaster condition applies, and/or because it is not delivered to WTRU 202 during or after the disaster condition applies.

In procedure 200, at 206, WTRU 202 registers for normal service on PLMN-D 204 and camps on a cell of PLMN-D 204, e.g., using a 5G RAT. In some implementations, WTRU 202 performs a registration procedure on a 5G mobile network, home PLMN (HPLMN) or a visited PLMN (VPLMN). In some implementations, the registration procedure in 5GS may be or include an initial registration, mobility, and/or or periodic registration procedure. In some implementations, WTRU 202 provides additional information about its capability to support a RAT utilization feature at 206. In some implementations, the RAT utilization capability support in WTRU 202 may be derived by WTRU 202, e.g., based on the presence of a new elementary file in the UICC (e.g., EF_{RATUtilInfo}—or other elementary file for storage of RAT Utilization information), or based on a configuration provided by the user of WTRU 202. Alternatively, in some implementations, the RAT Utilization capability support may be pre-configured in WTRU 202 (e.g., ME). It is noted that although the registration in this example scenario is on a 5GS, in some implementations a similar mechanism may be extended, e.g., to 4G (LTE) or previous generation networks (3g/2g) networks. In some such implementations, the 5G aspects of the registration procedure at 206 are replaced with attach and tracking area update procedures or other NAS control plane signaling procedures.

After the registration by WTRU 202 for normal service on PLMN-D 204 at 206, WTRU 202 receives NAS signaling 208 from PLMN-D 204. In some implementations, the NAS signaling 208 indicates and/or includes RAT utilization under disaster handling information. In some implementations, an AMF (network function), e.g., on reception of the NAS registration message with additional support for RAT utilization features, reads the RAT utilization information and RAT utilization under disaster handling information from a UDM/UDR identified for the subscription linked with the WTRU (SUPI/IMSI).

In some implementations, the RAT utilization information indicates RAT utilization restrictions (e.g., indicates which RATs are allowed and/or not allowed (e.g., with validity in scope of time and/or location for WTRU roaming partners, visited PLMNs during the national or international roaming, and/or the home PLMN)

In some implementations, the RAT utilization information is configured within the HPLMN UDM/UDR based on the service level agreements (SLAs), e.g., which the home operator has with national and international roaming operators. In some implementations, if WTRU 202 supports the new UICC elementary file (EF_{RATUtlInfo}) for RAT utilization storage, and/or based on operator deployment and policy, and/or the if the UDM supports communication with SP-AF (Secure Packet Application Function), WTRU 202 may send the RAT utilization information to the SP-AF requesting it to provide this information in a secured to be sent to the WTRU 202.

In some implementations, the RAT utilization under disaster handling information indicates how RAT utilization information should be handled when a disaster condition applies. For example, in some implementations, the RAT utilization under disaster handling information indicates whether RAT restrictions apply under disaster conditions. In some implementations, the RAT utilization under disaster handling information is communicated by the network operator to WTRU 202, e.g., as a pre-disaster configuration. In some implementations, e.g., alternatively, the RAT utilization under disaster handling information is pre-configured in WTRU 202 (e.g., ME or USIM).

In some implementations, the RAT Utilization information and RAT Utilization under disaster handling information is delivered to WTRU 202 by the network via NAS signaling (e.g., via Registration Accept, UCU, UE Parameters update procedure, Attach Accept, Tracking Area Update Accept, SoR container, Registration/Attach/TAU Reject messages, and/or NAS DL Transport message, etc.).

In some implementations, only the RAT utilization under disaster handling information provisioned by the network is used by WTRU 202, if both a RAT utilization under disaster handling information provisioned by the network and a pre-configured RAT utilization under disaster handling information are both present (e.g., stored in the WTRU and/or provided by the network. In some implementations, the network-provided information has priority over the WTRU stored information). In some implementations, if no RAT utilization under disaster handling information is provisioned by the network, and if WTRU 202 has a pre-configured RAT utilization under disaster handling information stored in the USIM and a pre-configured RAT utilization under disaster handling information stored in the ME, then only the pre-configured RAT utilization under disaster handling information stored in the USIM is used by WTRU 202.

In some implementations, the RAT utilization under disaster handling information, e.g., for a particular PLMN ID, may indicates whether RAT utilization information (i.e., RAT restrictions for PLMN ID), if available with the WTRU, is applicable under disaster conditions for the PLMN ID. In some implementations, this is indicated via a Boolean flag. For example, in some implementations, if the Boolean flag is true, RAT utilization information is applicable under disaster conditions, and if the Boolean flag is false, RAT utilization information (i.e., RAT restrictions for PLMN ID) is not applicable under disaster conditions. This is exemplary, and any suitable indication is usable.

In some implementations, optionally, RAT utilization under disaster handling information applies to one or more PLMN IDs. In some implementations, these PLMN IDs may also include equivalent PLMN IDs. In some implementations, the RAT Utilization under disaster handling information may include a different Boolean flag for each PLMN ID indicated in or by the RAT utilization under disaster handling information. In some implementations, the Boolean flag may indicate whether the RAT Utilization Information that is associated with the PLMN ID should be considered valid when the PLMN is in a disaster situation. For example, in some implementations, the Boolean flag has a first value (e.g., true or 1) if the RAT Utilization Information that is associated with the PLMN ID should be considered valid when the PLMN is in a disaster condition, and the Boolean flag has a second value (e.g., false or 0) if the RAT Utilization Information that is associated with the PLMN ID should be considered invalid when the PLMN is in a disaster condition.

In some implementations, e.g., in a scenario where no PLMN ID is provided by the RAT utilization under disaster handling information, the Boolean flag indicates whether the RAT utilization information stored in WTRU 202 (e.g., ME) is applicable (valid) or not applicable (invalid) under disaster situations. In other words, in such cases the flag provides “wildcard” applicability of the RAT utilization information under disaster conditions for all stored PLMN IDs.

In some implementations, e.g., alternatively, changes in the RAT Utilization under disaster handling information may be communicated by the UDM/UDR to the AMF and the AMF may deliver the updated RAT Utilization under disaster handling information to WTRU 202 via a NAS DL NAS TRANSPORT message, e.g., as part of a steering of roaming (SoR) transparent container or via other NAS Signaling messages, e.g., as described above. In some implementations, this update of the RAT Utilization information may occur while WTRU 202 is registered on the HPLMN or the visited PLMN (VPLMN).

In this example, at a time after WTRU 202 receives NAS signaling 208 from PLMN-D 204, the serving network goes under disaster conditions (i.e., disaster conditions apply to PLMN-D 204) at 210, and at a time after PLMN-D 204 goes under disaster conditions at 210, WTRU 202 detects that the PLMN-D 204 is under disaster conditions at 212.

In some implementations, WTRU 202 detects that the PLMN-D 204 is under disaster conditions at 212 in any suitable manner. For example, in some implementations, WTRU 202 may receive information (e.g., broadcast information) from a cell of PLMN-D 204 that indicates the disaster condition. In some implementations, WTRU 202 may receive a rejection of the registration procedure from PLMN-D 204, where the rejection indicates the rejection cause as a disaster condition. In some implementations, WTRU 202 may receive information (e.g., broadcast information) from a PLMN-A cell that includes the PLMN ID or a list of PLMN IDs that are subject to disaster conditions (e.g., including PLMN-D) or PLMN-X cell broadcast information including the PLMN ID or a list of PLMN IDs that are subject to the disaster i.e., including PLMN-D. PLMN-X indicates that it does not offer disaster roaming service, although it may be an allowable PLMN (not yet in the forbidden list for WTRU 202).

After WTRU 202 detects that the PLMN-D 204 is under disaster conditions at 212, WTRU 202 modifies its network (PLMN/SNPN) search and selection criteria at 214. In some implementations, WTRU 202 modifies its network (PLMN/SNPN) search and selection criteria based on the RAT utilization under disaster handling information.

In some implementations, based on the RAT utilization under disaster handling information, WTRU 202 may determine that RAT restrictions for PLMN-D 204 are not applicable under the current disaster conditions (i.e., other supported RATs/access technologies (e.g., 4G/GERAN) of PLMN-D 204, if available, on the are now valid PLMN selection candidates.) In some implementations, WTRU 202 may take into consideration this new information (e.g., that PLMN-D/4G and PLMN-D/GERAN are now allowable PLMNs) and assign the newly available PLMNs a higher priority for network search and selection purposes. In some implementations, similarly, RAT restrictions which are applicable to other PLMNs/Roaming partners/Equivalent PLMNs may be removed, such that all of these PLMNs are valid candidates to be considered for network search and selection purposes. In some implementations, WTRU 202 selects and attempts to register for service on PLMN/access technology combinations, where the PLMN-D with supported access technologies (i.e. PLMN-D RAT/access technologies are now considered allowed under disaster which were previously restricted as per the RAT Utilization information) is considered as the highest priority PLMN for the purpose of PLMN selection.

After WTRU 202 modifies its network (PLMN/SNPN) search and selection criteria at 214, WTRU 202 successfully finds PLMN-D 204 on the previously restricted RAT (e.g. 4G) 216, camps, and successfully registers to PLMN-D 204 on the previously restricted RAT 216 for normal services at 218.

In an example of pre-disaster configuration, in some implementations, a WTRU may receive RAT utilization under disaster handling information and RAT Utilization Information for a PLMN. In some implementations, the WTRU may be registered to the PLMN via a first RAT. In some implementations, the RAT utilization information for the PLMN may indicate that using a second RAT to access the PLMN is not allowed. In some implementations, the WTRU may later detect that the RAN of the PLMN that uses the first RAT is in a disaster condition. In some implementations, based on detecting the disaster, the WTRU may perform one of the following actions: attempt to access the PLMN via the second RAT (e.g., based on an indication in the RAT Utilization under disaster handling information, such as if the Boolean flag in the RAT Utilization under disaster handling information indicates FALSE), or attempt to access a forbidden PLMN by executing disaster roaming procedures (e.g., based on an indication in the RAT Utilization under disaster handling information, such as if the Boolean flag in the RAT Utilization under disaster handling information indicates TRUE)

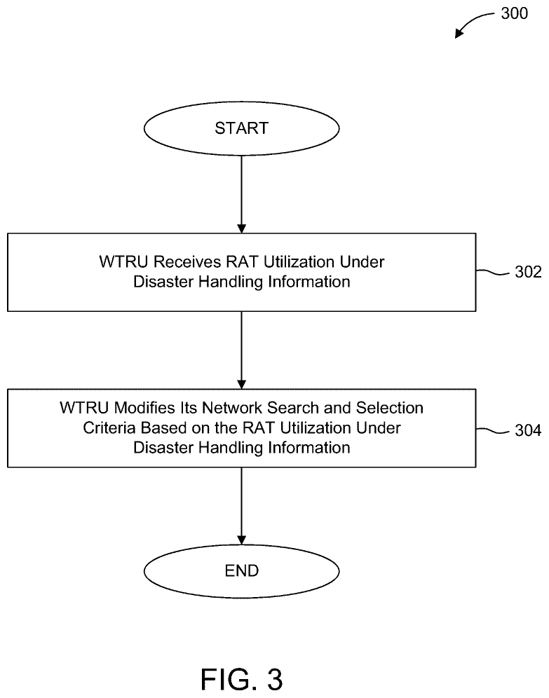

FIG. 3 is a flow chart illustrating an example method 300 for RAT utilization handling under disaster conditions, with pre-disaster configuration. At 302, the WTRU receives RAT Utilization under disaster handling information. In some implementations, the RAT Utilization under disaster handling information indicates how RAT Utilization information is to be handled when disaster conditions apply (i.e., indicates RAT Restrictions applicability under disaster conditions). In some implementations, the RAT Utilization under disaster handling information may be communicated to the WTRU by the network operator as a pre-disaster configuration. In some implementations, the RAT Utilization under disaster handling information may be pre-configured in a ME and/or USIM of the WTRU.

In some implementations, the RAT Utilization under disaster handling information includes or is a Boolean flag. In some implementations, RAT Restrictions are applicable under disaster condition if the Boolean flag has a first value (e.g. True or 1) and RAT Restrictions are not applicable under disaster conditions if the Boolean flag has a second value (e.g. False or 0). In some implementations, the WTRU behavior at 302 corresponds to step 208 as shown and described with respect to FIG. 2.

At 304, the WTRU modifies its network search and selection criteria based on the RAT Utilization under disaster handling information. For example, in some implementations, if the RAT utilization under disaster handling information indicates that RAT restrictions for PLMN-D on other PLMN-D supported RATs are no longer applicable (e.g., the WTRU is now allowed to access PLMN-D on a previously restricted RAT, such as 4G), the WTRU may modify its search and selection criteria to indicate that the previously restricted RAT is now allowable for PLMN-D and is assigned a higher priority for network search and selection purposes. In some implementations, similarly, RAT restrictions which are applicable to other PLMNs/Roaming partners/Equivalent PLMNs are removed and these PLMNs are valid candidates to for network search and selection purposes. In some implementations, the WTRU behavior at 304 corresponds to step 214 as shown and described with respect to FIG. 2

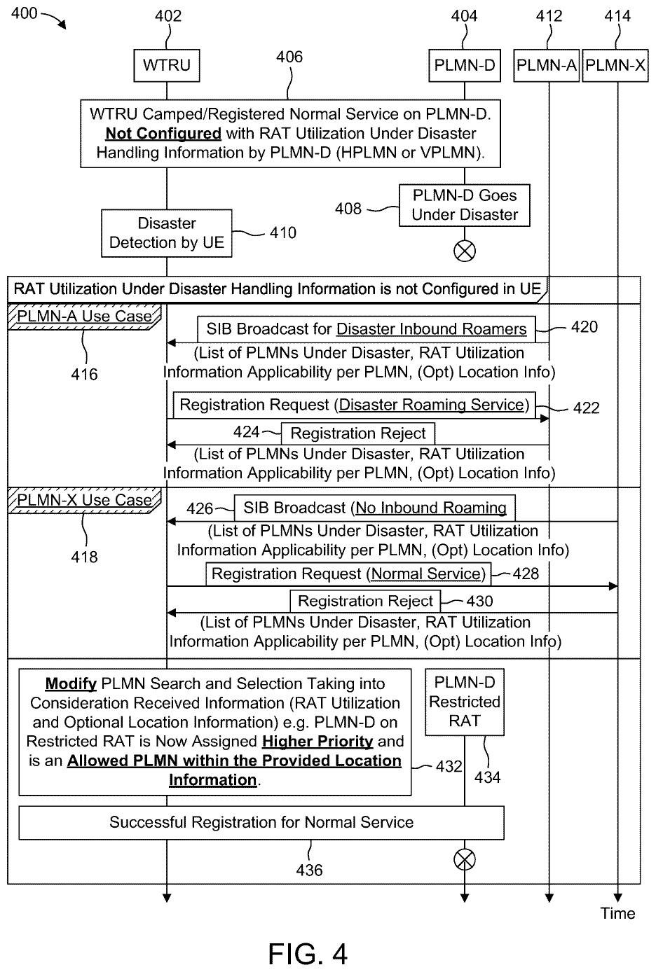

FIG. 4 is a message sequence chart illustrating aError! Reference source not found.n example procedure 400 for a WTRU 402 which receives RAT utilization information applicability per PLMN, (e.g., along with optional location information) after a disaster has occurred. This information may be referred to as a post-disaster configuration or provisioning, e.g., since it is not pre-configured in WTRU 402 and is made available to WTRU 402 after the serving PLMN-D 404 enters a disaster condition. In some implementations, the RAT utilization information applicability per PLMN information may be broadcast by PLMNs which are not under disaster conditions, e.g., through system information (SIB) broadcasts or NAS signaling messages.

In procedure 400, at 406, WTRU 402 registers for normal service on PLMN-D 404 and camps on a cell of PLMN-D 404, e.g., using a 5G RAT. In some implementations, WTRU 402 performs a registration procedure on a 5G mobile network, home PLMN (HPLMN) or a visited PLMN (VPLMN). In some implementations, the registration procedure in 5GS may be or include an initial registration, mobility, and/or or periodic registration procedure. The registration procedure in 5GS may be or include an initial registration, mobility, or periodic registration procedure. In some implementations, WTRU 402 provides additional information about its capability to support a RAT utilization feature at 406. In some implementations, the RAT utilization capability support in WTRU 402 may be derived by WTRU 402, e.g., based on the presence of a new elementary file in the UICC (e.g., EF_{RATUtilInfo}—or other elementary file for storage of RAT Utilization information), or based on a configuration provided by the user of WTRU 402. Alternatively, in some implementations, the RAT Utilization capability support may be pre-configured in WTRU 402 (e.g., ME).

In procedure 400, unlike in the pre-disaster configuration example of procedure 200 as shown and described with respect to FIG. 2, WTRU 402 is not provided with the RAT Utilization under disaster handling information by the network function (e.g. AMF). In some implementations, this may be because either RAT Utilization under disaster handling information is not configured in the UDM/UDR identified for the subscription linked with WTRU 402 (SUPI/IMSI) or the network function (e.g. AMF) did not provide this information to WTRU 402.

It is noted that although the registration in this example scenario is on a 5GS, in some implementations a similar mechanism may be extended, e.g., to 4G (LTE) or previous generation networks (3g/2g) networks. In some such implementations, the 5G aspects of the registration procedure at 406 are replaced with attach and tracking area update procedures or other NAS control plane signaling procedures.

At 408, the serving network goes under disaster i.e. disaster conditions apply to the PLMN-D, and at a time after PLMN-D 404 goes under disaster conditions at 408, WTRU 402 detects that PLMN-D 404 is under disaster conditions at 410.

In some implementations, WTRU 402 detects that the PLMN-D 404 is under disaster conditions at 410 in any suitable manner. In some implementations, WTRU 402 may receive a rejection of the registration procedure from PLMN-D 404 which indicates the rejection cause as a disaster condition. In some implementations, WTRU 202 may receive information (e.g., broadcast information) from a cell of PLMN-A 412 that includes the PLMN ID or a list of PLMN IDs that are subject to disaster conditions (e.g., including a PLMN-D 404) or PLMN-X 414 cell broadcast information including the PLMN ID or a list of PLMN IDs that are subject to the disaster i.e., including PLMN-D 404. PLMN-X 414 indicates that it does not offer disaster roaming service, although it may be an allowable PLMN (not yet in the forbidden list for WTRU 402).

At this point, RAT utilization disaster handling information is not configured in WTRU 402. Instead, RAT utilization disaster handling information is configured in WTRU 402 post-disaster. Example procedure 400 illustrates two example use cases of post-disaster provisioning.

In PLMN-A use case 416, at 420, a cell of PLMN-A 412 (NG-RAN) broadcasts disaster information, (e.g., via MIB, SIB1, and/or SIBx) in an area where the disaster condition applies to PLMN-D 404, while the disaster conditions are ongoing. In some implementations, PLMN-A 412 offers disaster inbound roaming to the subscribers of the PLMN-D 404 which is under disaster. Disaster inbound roaming enables subscribers from the PLMN-D which is under disaster to access normal services (e.g. voice and data) from the PLMN-A, which is offering disaster inbound roaming services.

In some implementations, such disaster information indicates RAT utilization information applicability per-PLMN, for PLMNs under disaster conditions, and optionally includes location information. The RAT Utilization information applicability per PLMN information indicates to the WTRU whether or not the RAT Utilization information stored for the PLMN is applicable under the disaster condition. In some implementations, the location information may be or include geo-fence information and/or a list of tracking areas, which when provided, restricts the applicability of the RAT Utilization information applicability per PLMN information to an area indicated by the provided location information (e.g., the list of tracking areas, geo-fence, etc.). In this example, the disaster information indicates PLMN-D 404 as being under disaster conditions. In some implementations, the disaster information is indicated using a flag (e.g., per-PLMN) to indicate whether a PLMN is under disaster conditions. In this example, the disaster information is indicated by a flag indicating that PLMN-D 404 is under disaster conditions.

If a RAT restriction (or restrictions) is removed for the PLMN under disaster conditions (e.g., as indicated by a flag of the RAT utilization information applicability per-PLMN information) to indicate RAT Utilization information applicability, the removal of the restriction can be linked with a provided optional location information. In some implementations, this means that RAT restrictions for the PLMN-D 404 are no longer applicable in an area indicated by the provided optional location information (e.g., only in this area). The optional location information indicates or includes the area in any suitable manner. For example, in some implementations, the optional location information indicates or includes a list of tracking areas or geofence information, etc. In some implementations, e.g., if the disaster information is broadcast via SIBx, WTRU 402 may request this additional SIBx on demand.

In PLMN-A use case 416, at 420, a cell of PLMN-A 412 (NG-RAN) broadcasts disaster information, (e.g., via MIB, SIB1, and/or SIBx) in an area where the disaster condition applies to PLMN-D 404, while the disaster conditions are ongoing.

Based on the disaster information from PLMN-A 412 at 420 offering disaster inbound roaming to WTRU 402, WTRU 402 triggers a registration procedure for disaster roaming services and sends a registration request to PLMN-A 412 at 422. In PLMN-A use case 416, PLMN-A 412 responds with a registration reject message 424, which includes disaster information (e.g., as described above). For example, in some implementations, such disaster information indicates RAT utilization information applicability per-PLMN, for PLMNs under disaster conditions, and optionally includes location information. In this example, the disaster information indicates PLMN-D 404 as being under disaster conditions. In some implementations, the disaster information is indicated using a flag (e.g., per-PLMN) to indicate whether a PLMN is under disaster conditions.

In some implementations, WTRU 402 performs the registration procedure on a 5G mobile network, home PLMN (HPLMN) or a visited PLMN (VPLMN). In some implementations, the registration procedure in 5G may be or include an initial registration, mobility, and/or or periodic registration procedure, or other NAS signaling procedure. It is noted that although the registration in this example scenario is on a 5GS, in some implementations a similar mechanism may be extended, e.g., to 4G (LTE) or previous generation networks (3g/2g) networks. In some such implementations, the 5G aspects of the registration procedure is replaced with attach and tracking area update procedures or other NAS control plane signaling procedures.

In PLMN-X use case 418, at 426, a cell of PLMN-X 414 (NG-RAN) broadcasts disaster information, (e.g., via MIB, SIB1, and/or SIBx) in an area where the disaster condition applies to PLMN-D 404, while the disaster conditions are ongoing. In some implementations PLMN-X does not offer disaster inbound roaming to the subscribers from the PLMN (PLMN-D 404 in this example) which is under disaster. In this example, PLMN-X 414 is a normal allowable PLMN and is not on the WTRU forbidden PLMNs list.

In some implementations, such disaster information indicates RAT utilization information applicability per-PLMN, for PLMNs under disaster conditions, and optionally includes location information. In some implementations the RAT Utilization information applicability per PLMN information indicates to the WTRU whether or not the RAT Utilization information stored for the PLMN is applicable under the disaster condition. The location information may be or include geo-fence information and/or a list of Tracking areas, which when provided, restricts the applicability of the RAT Utilization information applicability per PLMN information to an area indicated by the provided location information (e.g. list of tracking areas, geo-fence, etc.). In this example, the disaster information indicates PLMN-D 404 as being under disaster conditions. In some implementations, the disaster information is indicated using a flag (e.g., per-PLMN) to indicate whether a PLMN is under disaster conditions. In this example, the disaster information is indicated by a flag indicating that PLMN-D 404 is under disaster conditions.

If a RAT restriction (or restrictions) is removed for the PLMN under disaster conditions (e.g., as indicated by a flag of the RAT utilization information applicability per-PLMN information) to indicate RAT Utilization information applicability, the removal of the restriction can be linked with a provided optional location information. In some implementations, this means that RAT restrictions for the PLMN-D 404 are no longer applicable in an area indicated by the provided optional location information (e.g., only in this area). The optional location information indicates or includes the area in any suitable manner. For example, in some implementations, the optional location information indicates or includes a list of tracking areas or geofence information, etc. In some implementations, e.g., if the disaster information is broadcast via SIBx, WTRU 402 may request this additional SIBx on demand.

In this example, PLMN-X 414 is an allowable PLMN, and not part of the forbidden PLMN list for the WTRU 402. Accordingly, based on the disaster information from PLMN-X 414 at 426, WTRU 402 triggers a registration procedure for normal services and sends a registration request to PLMN-X 414 at 428. In PLMN-X use case 418, PLMN-X 414 responds with a registration reject message 430, which includes disaster information (e.g., as described above). For example, in some implementations, such disaster information indicates RAT utilization information applicability per-PLMN, for PLMNs under disaster conditions, and optionally includes location information. In this example, the disaster information indicates PLMN-D 404 as being under disaster conditions. In some implementations, the disaster information is indicated using a flag (e.g., per-PLMN) to indicate whether a PLMN is under disaster conditions.

In some implementations, the registration procedure in 5GS may be or include an initial registration, mobility, and/or or periodic registration procedure, or other NAS signaling procedure. It is noted that although the registration in this example scenario is on a 5GS, in some implementations a similar mechanism may be extended, e.g., to 4G (LTE) or previous generation networks (3g/2g) networks. In some such implementations, the 5G aspects of the registration procedure is replaced with attach and tracking area update procedures or other NAS control plane signaling procedures.

It is noted that in some cases the signaling described with respect to PLMN-X use case 418 (i.e., 426, 428, 430) may occur independently of, or in parallel with (e.g., overlapping and/or concurrently with) the signaling described with respect to PLMN-A use case 416 (i.e., 420, 422, 424). In some cases, only one of the use cases (i.e., either the PLMN-X use case 418 or the PLMN-A use case 416) may occur. In some scenarios it may happen that only either PLMN-A or PLMN-X behaves as per the described use case i.e., either 418 (i.e., 426, 428, 430) or 416 (i.e., 420, 422, 424). For example, if there is no available PLMN-X 414, the signaling associated with PLMN-X use case 418 (i.e., 426, 428, 430) may not be applicable, and may not occur.

Based on the disaster information received in PLMN-A use case 416 and/or PLMN-X use case 419, WTRU 402 modifies its network search and selection criteria at 432. In some implementations, WTRU 402 modifies its network search and selection criteria at 432 e.g., by taking into consideration RAT Utilization information applicability flag information and optionally location information received as part of the disaster information. For example, in some implementations, if as per a RAT Utilization information applicability flag, RAT restrictions for PLMN-D 404 on other RATs are no longer applicable (e.g., PLMN-D 404 is now allowed to access PLMN-D 404 the 4G RAT). In another example, if as per the RAT utilization information applicability flag and optional location information, RAT restrictions PLMN-D 404 on other RATs are no longer applicable at the current location of WTRU 402, WTRU 402 is now allowed to access PLMN-D 404 on the 4G RAT at the present location.

In some implementations, WTRU 402 takes into consideration this new information that accessing PLMN-D on 4G no longer restricted (i.e., is now an allowable PLMN), and assigns this combination of RAT and PLMN (i.e., PLMN-D on 4G in this example) a higher priority for network search and selection purpose. Similarly, in some implementations, RAT restrictions which are applicable to other PLMNs, roaming partners, and/or equivalent PLMNs are removed, and these PLMNs also become valid candidates for network search and selection purposes. In some implementations, if optional location information is present, WTRU 402 links the location (e.g., list of TAs, geofence location etc.) with the RAT restriction applicability information (i.e., the RAT restriction is removed for PLMNs in this location).

After WTRU 402 modifies its network search and selection criteria at 432, WTRU 402 successfully finds PLMN-D 404 on the previously restricted RAT (e.g. 4G) 434, camps, and successfully registers to PLMN-D 404 on the previously restricted RAT 434 for normal services at 436.

In an example of post-disaster provisioning, in some implementations, a WTRU may receive RAT utilization information for a first PLMN. In some implementations, the WTRU may be registered to the PLMN via a first RAT. In some implementations, the RAT utilization information for the PLMN may indicate that using a second RAT to access the PLMN is not allowed. In some implementations, the WTRU may later detect that the RAN of the PLMN that uses the first RAT is in a disaster condition. In some implementations, based the detecting the disaster, the WTRU may begin a disaster roaming procedure. In some implementations, e.g., as part of the disaster roaming procedure, the WTRU may read a SIB information that is broadcast by a second PLMN (i.e. a forbidden PLMN). In some implementations, the SIB information may include a RAT Utilization information applicability flag. In some implementations, the second PLMN (PLMN-A in this example) may indicate (e.g., in the SIB) that the first PLMN (PLMN-D in this example) and the SIB indicate RAT Utilization information applicability information associated with the first PLMN. In some implementations, the RAT utilization information applicability information may be or include a Boolean flag.

In some implementations, if the RAT utilization information applicability information indicates that the RAT restriction is no longer in effect (e.g., if the Boolean flag indicates FALSE), then the WTRU may attempt to access the first PLMN via the second RAT (i.e., because the RAT utilization information for the first PLMN is not currently applicable). In some implementations, if the RAT utilization information applicability information indicates that the RAT restriction remains in effect (e.g., if the Boolean flag indicates TRUE), then the WTRU may attempt to access the forbidden PLMN by executing disaster roaming procedures (i.e., may try to register to the second PLMN, which is a forbidden PLMN) and will not attempt to access the first PLMN via the second RAT (i.e., the RAT utilization information for the first PLMN is still applicable).

In some implementations, instead of broadcasting a Boolean RAT utilization information applicability flag, the second PLMN may broadcast an indication of the identities of PLMNs that are under a disaster condition, but whose roamers the second PLMN is not willing to serve. In some implementations, the WTRU may accordingly infer that, since a PLMN is under a disaster situation and the second PLMN is not willing to serve roamers from the second PLMN, the PLMN may be accessible via different RAT or RATS, and the WTRU may assume that the RAT utilization information is no longer applicable.

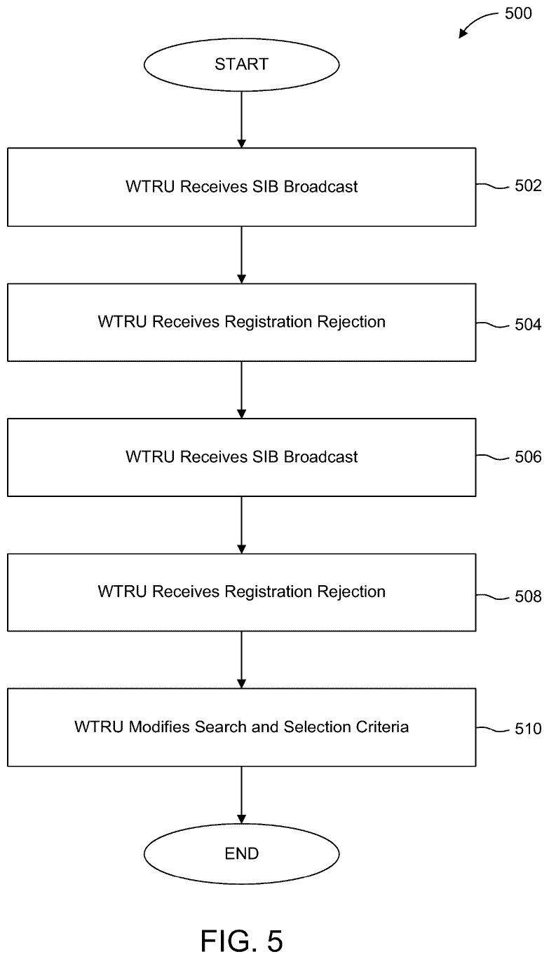

FIG. 5 is a flow chart illustrating an example method 500 for RAT utilization handling under disaster conditions, with post-disaster provisioning. At 502, in some implementations, the WTRU listens to cell broadcasts from the NG-RAN cell of a PLMN-A which broadcasts disaster information (e.g., via MIB, SIB1, and/or SIBx) in an area where the disaster condition applies to a PLMN (e.g., PLMN-D), while the disaster conditions are ongoing. In some implementations, the disaster information indicates or includes a list of PLMNs under disaster conditions (e.g. including PLMN-D). In some implementations, the disaster information includes information (e.g., a flag) indicating RAT utilization information applicability per PLMN in the list of PLMNs under disaster, and optionally includes information indicating location information. In some implementations, if the RAT restrictions are removed for the PLMN under disaster as per the indication of RAT Utilization information applicability, this removal of the restriction may also be linked with the optional location information if provided. For example, in some implementations, this means that RAT restrictions for the PLMN-D are no longer applicable in the area (e.g., only in this area) indicated by the provided optional location information. In some implementations, the optional location information indicates the area by indicating or including a list of tracking areas, indicating or including geofence information, etc. In some implementations, e.g., if the disaster information is broadcast via SIBx, the WTRU may request this additional SIBx on demand. In some implementations, the WTRU behavior at 502 corresponds to step 420 as shown and described with respect to FIG. 4.

At 504, in some implementations, the WTRU receives a registration rejection message from the PLMN-A and registration reject message includes disaster information, e.g., as described above. In some implementations, the WTRU behavior at 504 corresponds to step 424 as shown and described with respect to FIG. 4.

At 506, in some implementations, the WTRU listens to cell broadcasts from the NG-RAN cell of the PLMN-X which broadcasts disaster information (e.g., by MIB, SIB1, and/or SIBx) in an area where the disaster condition applies to a PLMN (e.g., PLMN-D), while the disaster conditions are ongoing. In some implementations, the disaster information indicates or includes a list of PLMNs under disaster conditions (e.g. including PLMN-D). In some implementations, the disaster information includes information (e.g., a flag) indicating RAT utilization information applicability per PLMN in the list of PLMNs under disaster, and optionally includes information indicating location information. In some implementations, if the RAT restrictions are removed for the PLMN under disaster as per the indication of RAT Utilization information applicability, this removal of the restriction may also be linked with the optional location information if provided. For example, in some implementations, this means that RAT restrictions for the PLMN-D are no longer applicable in the area (e.g., only in this area) indicated by the provided optional location information. In some implementations, the optional location information indicates the area by indicating or including a list of tracking areas, indicating or including geofence information, etc. In some implementations, e.g., if the disaster information is broadcast via SIBx, the WTRU may request this additional SIBx on demand. In some implementations, the WTRU behavior at 506 corresponds to step 426 as shown and described with respect to FIG. 4.

At 508, in some implementations, the WTRU receives a registration rejection message from the PLMN-A and registration reject message includes disaster information, e.g., as described above. In some implementations, the WTRU behavior at 508 corresponds to step 430 as shown and described with respect to FIG. 4.

At 510, in some implementations, the WTRU modifies its network search and selection criteria based on the RAT Utilization information applicability information (e.g., flag) and optionally, location information. For example, in some implementations, if the RAT utilization information applicability information (e.g., flag), indicates that RAT restrictions for PLMN-D on other PLMN-D supported RATs are no longer applicable (e.g., the WTRU is now allowed to access PLMN-D on a previously restricted RAT, such as 4G. For example, if the RAT utilization information applicability information (e.g., flag) and optional location information indicates that RAT restrictions on the WTRU for accessing PLMN-D on other RATs are no longer applicable, e.g., at the current location of the WTRU, PLMN-D is now accessible to the WTRU on the previously restricted RAT (e.g., RAT 4G), e.g., at the present location.

In some implementations, the WTRU may modify its search and selection criteria to indicate that the previously restricted RAT is now allowable for PLMN-D and is assigned a higher priority for network search and selection purposes. In some implementations, similarly, RAT restrictions which are applicable to other PLMNs/Roaming partners/Equivalent PLMNs are removed and these PLMNs are valid candidates to for network search and selection purposes. In some implementations, if optional location information is present, the RAT restriction validity is linked with the location (e.g., list of TAs, geofence location etc.). In some implementations, the WTRU behavior at 510 corresponds to step 432 as shown and described with respect to FIG. 4.

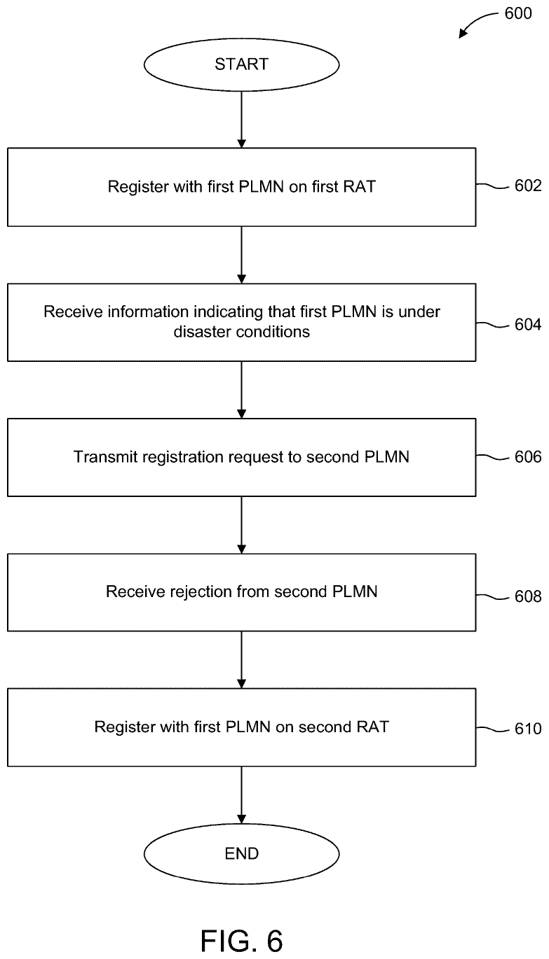

FIG. 6 is a flowchart illustrating an example method 600 for handling of RAT utilization under disaster conditions. At 602, a WTRU registers with a first PLMN on a first RAT. In some implementations, the WTRU receives information indicating that a restriction on a second RAT is applicable for the first PLMN.

At 604, the WTRU receives information indicating that the first PLMN is under a disaster condition. In some implementations, the information indicating that the first PLMN is under the disaster condition is received in a broadcast from a second PLMN. In some implementations, the broadcast is or includes a system information block (SIB). In some implementations, if the broadcast is or includes a SIB, the WTRU may request an additional SIB that includes information indicating that a restriction on the second RAT is not applicable for the first PLMN and indicating location information.

At 606, the WTRU transmits a registration request to the second PLMN. In some implementations, the registration request to the second PLMN indicates a request for disaster roaming service (e.g., PLMN-A use case as shown and described with respect to FIG. 4). In some implementations, the registration request to the second PLMN indicates a request for normal service (e.g., PLMN-X use case as shown and described with respect to FIG. 4).

At 608, the WTRU receives a rejection from the second PLMN. In some implementations, the registration rejection message from the second PLMN includes information indicating that a restriction on the second RAT is not applicable to the WTRU for the first PLMN. In some implementations, the WTRU receives, from the second PLMN, information indicating that a restriction on the second RAT is not applicable for the first PLMN.

At 610, the WTRU registers with the first PLMN on a second RAT. In some implementations, the information indicating that the first PLMN is under the disaster condition includes location information, wherein the information indicating that the restriction on the second RAT is not applicable to the WTRU for the first PLMN is applicable within a geographic area that is based on the location information. In some implementations, the first RAT is a 5G RAT. In some implementations, the second RAT is a 4G RAT.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a wireless transmit/receive unit (WTRU), the method comprising:
registering with a first public land mobile network (PLMN) on a first radio access technology (RAT);
receiving, from the first PLMN, information indicating that a restriction on a second RAT is applicable for the first PLMN;
receiving information indicating that the first PLMN is under a disaster condition;
transmitting a registration request to a second PLMN;
receiving a registration rejection message from the second PLMN;
receiving, from the second PLMN, information indicating that the restriction on the second RAT is not applicable for the first PLMN; and
registering with the first PLMN on the second RAT.

2. The method of claim 1, wherein the information indicating that the first PLMN is under the disaster condition is received in a broadcast from the second PLMN.

3. The method of claim 2, wherein the broadcast comprises a system information block (SIB).

4. The method of claim 3, further comprising requesting an additional SIB that includes information indicating that the restriction on the second RAT is not applicable for the first PLMN, and location information, responsive to the broadcast SIB.

5. The method of claim 1, wherein the registration request to the second PLMN indicates a request for disaster roaming service.

6. The method of claim 1, wherein the registration request to the second PLMN indicates a request for normal service.

7. The method of claim 1, wherein the registration rejection message from the second PLMN includes information indicating that the restriction on the second RAT is not applicable to the WTRU for the first PLMN.

8. The method of claim 7, wherein the information indicating that the first PLMN is under the disaster condition includes location information, wherein the information indicating that the restriction on the second RAT is not applicable to the WTRU for the first PLMN is applicable within a geographic area that is based on the location information.

9. The method of claim 1, wherein the first RAT comprises a 5G RAT.

10. The method of claim 1, wherein the second RAT comprises a 4G RAT.

11. A wireless transmit/receive unit (WTRU) comprising:
circuitry configured to register with a first public land mobile network (PLMN) on a first radio access technology (RAT);
circuitry configured to receive, from the first PLMN, information indicating that a restriction on a second RAT is applicable for the first PLMN;
circuitry configured to receive information indicating that the first PLMN is under a disaster condition;
circuitry configured to transmit a registration request to a second PLMN;
circuitry configured to receive a registration rejection message from the second PLMN;
circuitry configured to receive, from the second PLMN, information indicating that the restriction on the second RAT is not applicable for the first PLMN; and
circuitry configured to register with the first PLMN on the second RAT.

12. The WTRU of claim 11, wherein the circuitry configured to receive the information indicating that the first PLMN is under the disaster condition is configured to receive the information indicating that the first PLMN is under the disaster condition in a broadcast from the second PLMN.

13. The WTRU of claim 12, wherein the broadcast comprises a system information block (SIB).

14. The WTRU of claim 13, further comprising circuitry configured to receive an additional SIB that includes information indicating that the restriction on the second RAT is not applicable for the first PLMN, and location information, responsive to the broadcast SIB.

15. The WTRU of claim 11, wherein the registration request to the second PLMN indicates a request for disaster roaming service.

16. The WTRU of claim 11, wherein the registration request to the second PLMN indicates a request for normal service.

17. The WTRU of claim 11, wherein the registration rejection message from the second PLMN includes information indicating that the restriction on the second RAT is not applicable to the WTRU for the first PLMN.

18. The WTRU of claim 17, wherein the information indicating that the first PLMN is under the disaster condition includes location information, wherein the information indicating that the restriction on the second RAT is not applicable to the WTRU for the first PLMN is applicable within a geographic area that is based on the location information.

19. The WTRU of claim 11, wherein the first RAT comprises a 5G RAT.

20. The WTRU of claim 11, wherein the second RAT comprises a 4G RAT.
